(19) United States
(12) Patent Application Publication
(10) Pub. No.: US 2004/0246381 A1
(43) Pub. Date: Dec. 9, 2004

(54) System and method of performing dot inversion with standard drivers and backplane on novel display panel layouts

(76) Inventor: Thomas Lloyd Credelle, Morgan Hill, CA (US)

Correspondence Address: CLAIRVOYANTE, INC., 874 GRAVENSTEIN HIGHWAY SOUTH, SUITE 14, SEBASTOPOL, CA, 95472, US

(21) Appl. No.: 10/455,931

(22) Filed: Jun. 6, 2003

(51) Int. Cl. G09G 3/36; H04N 9/72

(52) U.S. Cl. 348/692

(57) ABSTRACT

A system and method are disclosed for performing dot inversion with standard drivers and backplane on novel display panel layouts. Suitable dot inversion schemes are implmented on a liquid crystal display having a panel and a driver circuit. The panel substantially comprises a subpixel repeating group, the group having a even number of subpixels across a first direction. The driver circuit comprises a set of drivers, coupled to the panel providing image data signals to the panel, the signals effecting substantially a dot inversion scheme to the panel. The drivers are also substantially connected to the columns of the panel in a sequence along the driver circuit wherein at least one driver is not connected to a column of the panel, and at least two subpixel regions of the panel having same colored subpixels in the two regions with substantially different polarities.

### RELATED APPLICATIONS

The present application is related to commonly owned (and filed on even date) U.S. patent applications: (1) U.S. patent application Ser. No. ______ entitled “DISPLAY PANEL HAVING CROSSOVER CONNECTIONS EFFECTING DOT INVERSION”; and (2) U.S. patent application Ser. No. ______ entitled “SYSTEM AND METHOD FOR COMPENSATING FOR VISUAL EFFECTS UPON PANELS HAVING FIXED PATTERN NOISE WITH REDUCED QUANTIZATION ERROR”; (3) U.S. patent application Ser. No. ______ entitled “DOT INVERSION ON NOVEL DISPLAY PANEL LAYOUTS WITH EXTRA DRIVERS”; (4) U.S. patent application Serial No. ______ entitled “LIQUID CRYSTAL DISPLAY BACKPLANE LAYOUTS AND ADDRESSING FOR NON-STANDARD SUBPIXEL ARRANGEMENTS”; and (5) U.S. patent application Ser. No. ______ entitled “IMAGE DEGRADATION CORRECTION IN NOVEL LIQUID CRYSTAL DISPLAYS,” which are hereby incorporated herein by reference.

### BACKGROUND

In commonly owned U.S. patent applications: (1) U.S. patent application Ser. No. 09/916,232 (“the '232 application”), entitled “ARRANGEMENT OF COLOR PIXELS FOR FULL COLOR IMAGING DEVICES WITH SIMPLIFIED ADDRESSING,” filed Jul. 25, 2001; (2) U.S. patent application Ser. No. 10/278,353 (“the '353 application”), entitled “IMPROVEMENTS TO COLOR FLAT PANEL DISPLAY SUB-PIXEL ARRANGEMENTS AND LAYOUTS FOR SUB-PIXEL RENDERING WITH INCREASED MODULATION TRANSFER FUNCTION RESPONSE,” filed Oct. 22, 2002; (3) U.S. patent application Ser. No. 10/278,352 (“the '352 application”), entitled “IMPROVEMENTS TO COLOR FLAT PANEL DISPLAY SUB-PIXEL ARRANGEMENTS AND LAYOUTS FOR SUB-PIXEL RENDERING WITH SPLIT BLUE SUB-PIXELS,” filed Oct. 22, 2002; (4) U.S. patent application Ser. No. 10/243,094 (“the '094 application”), entitled “IMPROVED FOUR COLOR ARRANGEMENTS AND EMITTERS FOR SUB-PIXEL RENDERING,” filed Sep. 13, 2002; (5) U.S. patent application Ser. No. 10/278,328 (“the '328 application”), entitled “IMPROVEMENTS TO COLOR FLAT PANEL DISPLAY SUB-PIXEL ARRANGEMENTS AND LAYOUTS WITH REDUCED BLUE LUMINANCE WELL VISIBILITY,” filed Oct. 22, 2002; (6) U.S. patent application Ser. No. 10/278,393 (“the '393 application”), entitled “COLOR DISPLAY HAVING HORIZONTAL SUB-PIXEL ARRANGEMENTS AND LAYOUTS,” filed Oct. 22, 2002; (7) U.S. patent application Ser. No. 01/347,001 (“the '001 application”) entitled “IPROVED SUB-PIXEL ARRANGEMENTS FOR STRIPED DISPLAYS AND METHODS AND SYSTEMS FOR SUB-PIXEL RENDERING SAME,” filed Jan. 16, 2003, novel sub-pixel arrangements are therein disclosed for improving the cost/performance curves for image display devices and herein incorporated by reference.

These improvements are particularly pronounced when coupled with sub-pixel rendering (SPR) systems and methods further disclosed in those applications and in commonly owned U.S. patent applications: (1) U.S. patent application Ser. No. 10/051,612 (“the '612 application”), entitled “CONVERSION OF RGB PIXEL FORMAT DATA TO PENTILE MATRIX SUB-PIXEL DATA FORMAT,” filed Jan. 16, 2002; (2) U.S. patent application Ser. No. 10/150,355 (“the '355 application”), entitled “METHODS AND SYSTEMS FOR SUB-PIXEL RENDERING WITH GAMMA ADJUSTMENT,” filed May 17, 2002; (3) U.S. patent application Ser. No. 10/215,843 (“the '843 application”), entitled “METHODS AND SYSTEMS FOR SUB-PIXEL RENDERING WITH ADAPTIVE FILTERING,” filed Aug. 8, 2002; (4) U.S. patent application Ser. No. 10/379,767 entitled “SYSTEMS AND METHODS FOR TEMPORAL SUB-PIXEL RENDERING OF IMAGE DATA” filed Mar. 4, 2003; (5) U.S. patent application Ser. No. 10/379,765 entitled “SYSTEMS AND METHODS FOR MOTION ADAPTIVE FILTERING,” filed Mar. 4, 2003; (6) U.S. patent application Ser. No. 10/379,766 entitled “SUB-PIXEL RENDERING SYSTEM AND METHOD FOR IMPROVED DISPLAY VIEWING ANGLES” filed Mar. 4, 2003; (7) U.S. patent application Ser. No. 10/409,413 entitled “IMAGE DATA SET WITH EMBEDDED PRE-SUBPIXEL RENDERED IMAGE” filed Apr. 7, 2003, which are hereby incorporated herein by reference.

### BRIEF DESCRIPTION OF THE DRAWINGS

The accompanying drawings, which are incorporated in, and constitute a part of this specification illustrate exemplary implementations and embodiments of the invention and, together with the description, serve to explain principles of the invention.

FIG. 1A depicts a typical RGB striped panel display having a standard 1×1 dot inversion scheme.

FIG. 1B depicts a typical RGB striped panel display having a standard 1×2 dot inversion scheme.

FIG. 2 depicts a novel panel display comprising a subpixel repeat grouping that is of even modulo.

FIG. 3 depicts the panel display of FIG. 2 with one column driver skipped to provide a dot inversion scheme that may abate some undesirable visual effects.

### DETAILED DESCRIPTION

Reference will now be made in detail to implementations and embodiments, examples of which are illustrated in the accompanying drawings. Wherever possible, the same reference numbers will be used throughout the drawings to refer to the same or like parts.

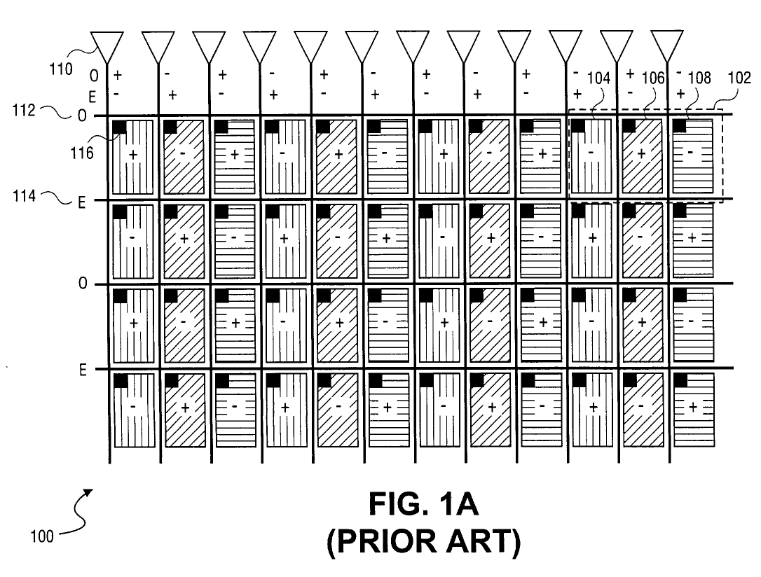

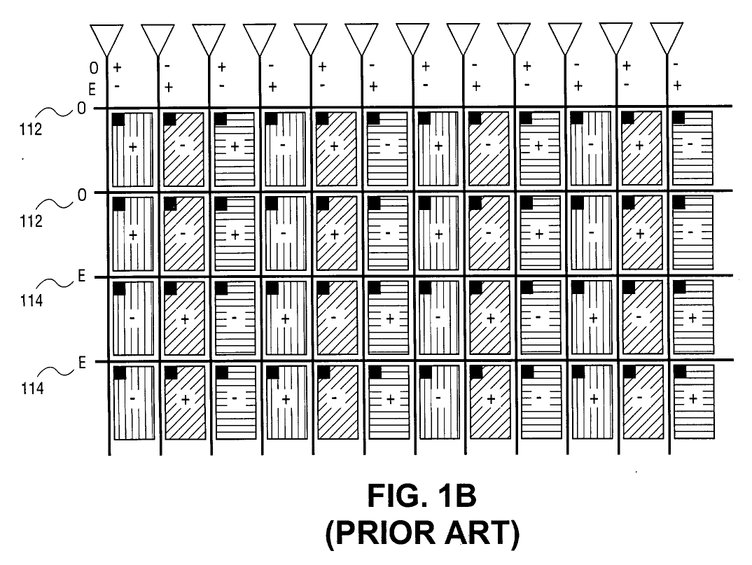

FIG. 1A shows a conventional RGB stripe structure on panel 100 for an Active Matrix Liquid Crystal Display (AMLCD) having thin film transistors (TFTs) 116 to activate individual colored subpixels—red 104, green 106 and blue 108 subpixels respectively. As may be seen, a red, a green and a blue subpixel form a repeating group of subpixels 102 that comprise the panel.

As also shown, each subpixel is connected to a column line (each driven by a column driver 110) and a row line (e.g. 112 and 114). In the field of AMLCD panels, it is known to drive the panel with a dot inversion scheme to reduce crosstalk and flicker. FIG. 1A depicts one particular dot inversion scheme—i.e. 1×1 dot inversion—that is indicated by a “+” and a “−” polarity given in the center of each subpixel. Each row line is typically connected to a gate (not shown in FIG. 1A) of TFT 116. Image data—delivered via the column lines—are typically connected to the source of each TFT. Image data is written to the panel a row at a time and is given a polarity bias scheme as indicated herein as either ODD (“O”or EVEN (“E”schemes. As shown, row 112 is being written with ODD polarity scheme at a given time while row 114 is being written with EVEN polarity scheme at a next time. The polarities alternate ODD and EVEN schemes a row at a time in this 1×1 dot inversion scheme.

FIG. 1B depicts another conventional RGB stripe panel having another dot inversion scheme—i.e. 1×2 dot inversion. Here, the polarity scheme changes over the course of two rows as opposed to every row, as in 1×1 dot inversion. In both dot inversion schemes, a few observations are noted: (1) in 1×1 dot inversion, every two physically adjacent subpixels (in both the horizontal and vertical direction) are of different polarity; (2) in 1×2 dot inversion, every two physically adjacent subpixels in the horizontal direction are of different polarity; (3) across any given row, each successive colored subpixel has an opposite polarity to its neighbor. Thus, for example, two successive red subpixels along a row will be either (+,−) or (−,+). Of course, in 1×1 dot inversion, two successive red subpixels along a column with have opposite polarity; whereas in 1×2 dot inversion, each group of two successive red subpixels will have opposite polarity. This changing of polarity decreases noticeable visual effects that occur with particular images rendered upon an AMLCD panel. It is generally known that the visual defects vertically will be minimal if the polarity of the same-color pixels changes frequently, but not necessarily every row; thus the 1×2 dot inversion is acceptable.

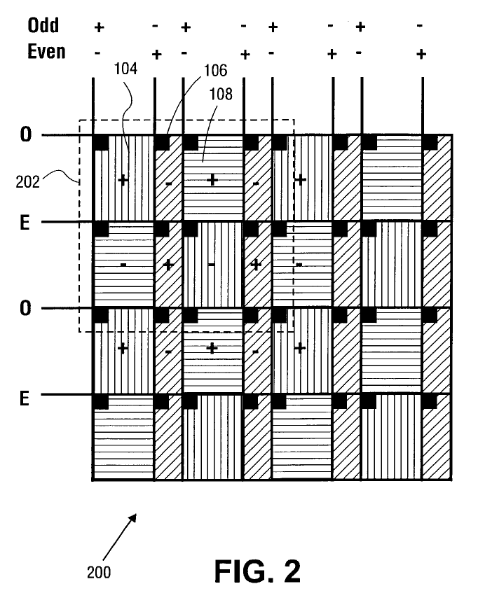

FIG. 2 shows a panel comprising a repeat subpixel grouping 202, as further described in the '353 application. As may be seen, repeat subpixel grouping 202 is an eight subpixel repeat group, comprising a checkerboard of red and blue subpixels with two columns of reduced-area green subpixels in between. If the standard 1×1 dot inversion scheme is applied to a panel comprising such a repeat grouping (as shown in FIG. 2), then it becomes apparent that the property described above for RGB striped panels (namely, that successive colored pixels in a row and/or column have different polarities) is now violated. This condition may cause a number of visual defects noticed on the panel—particularly when certain image patterns are displayed. This observation also occurs with other novel subpixel repeat grouping—for example, the subpixel repeat grouping in FIG. 1 of the '352 application—and other repeat groupings that are not an odd number of repeating subpixels across a row. Thus, as the traditional RGB striped panels have three such repeating subpixels in its repeat group (namely, R, G and B), these traditional panels do not necessarily violate the above noted conditions. However, the repeat grouping of FIG. 2 in the present application has four (i.e. an even number) of subpixels in its repeat group across a row (e.g. R, G, B, and G). It will be appreciated that the embodiments described herein are equally applicable to all such even modulus repeat groupings.

In the '232 co-pending application, there is disclosed various layouts and methods for remapping the TFT backplane so that, although the TFTs of the subpixels may not be regularly positioned with respect to the pixel element itself (e.g. the TFT is not always in the upper left hand comer of the pixel element), a suitable dot inversion scheme may be effected on a panel having an even modulo subpixel repeat grouping. Other possible solutions are disclosed in the co-pending applications noted above.

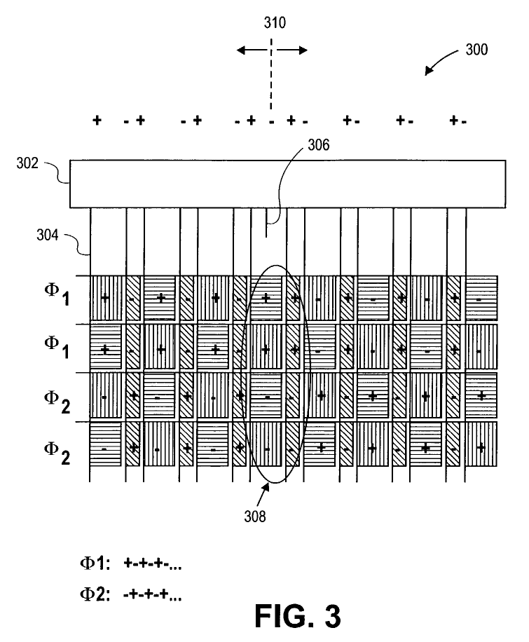

One possible implementation that would not necessarily require a redesign of the TFT backplane or column driver chips is shown below in FIG. 3. Panel 300 comprises the subpixel repeating group as shown in FIG. 2. Column driver chip 302 connects to panel 300 via column lines 304. Chip 302, as shown, effects a 1×2 dot inversion scheme on panel 300—as indicated by the “+” and “−” polarities indicated in each subpixel. The phase of pluses and minuses are indicated by the nomenclature Φ1 and Φ2.

As may be seen, at certain points along chip 302, there are column drivers that are not used (as indicated by short column line 306). “Skipping” a column driver in such a fashion on creates the desirable effect of providing alternating areas of dot inversion for same colored subpixels. For example, on the left side of dotted line 310, it can be seen that the red colored subpixels along a given row have the same polarity. However, on the right side of dotted line 310, the polarities of the red subpixels change. This change may have the desired effect of eliminating or abating any visual shadowing effects that might occur as a result of same-colored subpixel all having the same polarity.

This column driver skipping may be accomplished often enough across an entire panel to reduce or eliminate shadowing effects. How many times and in any given pattern may be determined heuristically. One possible side effect of skipping column drivers might be that—at the columns where the driver is skipped, those adjoining columns have the same polarities going down the column line. This may have an undesirable visual effect, such as producing a darker or lighter column at this point—as depicted as oval 308.

As it is known upon manufacture of the panel itself where these skipped column drivers are on the panel, it is possible to compensate for any undesirable visual effect. As described in copending and commonly assigned patent application, entitled “SYSTEM AND METHOD FOR COMPENSATING FOR VISUAL EFFECTS UPON PANELS HAVE NON-STANDARD DOT INVERSION SCHEMES” and incorporated herein by reference, there are techniques that may be employed to reduce or possibly eliminate these visual effects. For example, a noise pattern may be introduced to the potential effected columns such that known or estimated darkness or brightness produce by such columns are adjusted. For example, if the column in question is slightly darker than those surrounding columns then the darker column may be adjusted to be slightly more ON than its neighbors, maybe adjusted to be slightly more ON than its neighbors.

It will be appreciated that, although it might be the easiest to skip one driver in the sequence of drivers along the driver circuit—and thereby having two adjacent columns of subpixels driven with the same polarity (thus, creating different regions of same colored subpixel polarity along a row), that there are other ways (perhaps less easy) to implement this effect. For example, it is possible to skip several (e.g. 3, 5, etc) drivers along a driver circuit to accomplish the same result. Additionally, it might be possible to skip drivers that are not in sequence and achieve the same desired effect with crossover connections or other interconnects. It suffices for the purposes of the present invention that a certain number of drivers are not used to create a more visually appealing panel.

Additionally, the technique of skipping drivers along a driver circuit is easily implemented with standard driver circuits wherein drivers in a sequence alternate polarity themselves. However, it is within the scope of the present invention whereby specialty driver circuits are constructed such that at least two adjacent drivers have the same polarity and thus the regions of different polarities of same colored subpixels may be effected by connecting these specialty drivers sequentially along the driver circuit.

The number of places or regions where same colored subpixel polarity is reversed can be determined heuristically or empirically. It suffices that such polarity reversals occur often enough to produce a panel that has user acceptability.

What is claimed is:

1. A liquid crystal display comprising:
a panel substantially comprising a subpixel repeating group, the group having a even number of subpixels across a first direction; and
a driver circuit, comprising a set of drivers, coupled to the panel providing image data signals to the panel, the signals effecting substantially a dot inversion scheme to the panel, the drivers being substantially connected to the columns of the panel in a sequence along the driver circuit wherein at least one driver is not connected to a column of the panel, and at least two subpixel regions of the panel having same colored subpixels in the two regions with substantially different polarities.

2. The liquid crystal display of claim 1, wherein the first direction is along a row of the subpixel repeating group.

3. The liquid crystal display of claim 1, wherein the first direction is along a column of the subpixel repeating group.

4. The liquid crystal display of claim 1, wherein the subpixel repeating group comprises a Bayer pattern.

5. The liquid crystal display of claim 1, wherein the subpixel repeating group comprises the sequence of red R green G blue B green G colored subpixels along a row direction.

6. The liquid crystal display of claim 1, wherein the dot inversion scheme is a 1×1 dot inversion scheme.

7. The liquid crystal display of claim 1, wherein the dot inversion scheme is a 1×2 dot inversion scheme.

8. The liquid crystal display of claim 1, wherein the number of subpixel regions having same colored subpixels with different polarities occur with a frequency such that undesirable visual effects are abated.

9. A liquid crystal display comprising:
a panel comprising a plurality of at least a first and a second colored subpixels, the panel further comprising a plurality of regions wherein the first colored subpixels have a same polarity; and
a set of drivers connected to the columns of the panel such that the drivers are connected so that at least two adjacent regions have different polarities for the first colored subpixels.

10. The liquid crystal display of claim 9, wherein the set of drivers are connected in a sequence to the columns and the two adjacent regions have two bordering columns of same polarity.

11. A method for effecting a dot inversion scheme upon subpixels of a liquid crystal display, the display substantially comprising a subpixel repeat grouping of even number along a first direction, the method comprising:
determining regions of same polarity for same colored subpixels in a panel; and
connecting drivers to column lines substantially in a sequence such that at least two adjacent regions of same polarity for same colored subpixels have different polarities for said same colored subpixels.

12. The method of claim 11, further comprising:
providing a number of adjacent regions with different polarities for same colored subpixels with a frequency of polarity changes to abate undesirable visual effects.

13. A driver circuit for a liquid crystal display comprising:
a set of drivers coupled to a panel having subpixel regions, the drivers providing image data signals to the panel, the signals effecting substantially a dot inversion scheme to the panel, the drivers being substantially connected to columns of the panel in a sequence along the driver circuit wherein at least one driver is not connected to a column of the panel, and at least two subpixel regions of the panel having same colored subpixels in the two regions with substantially different polarities.

14. A method for effecting a dot inversion scheme upon subpixels of a liquid crystal display, the display substantially comprising a subpixel repeat grouping of even number along a first direction, the method comprising:
connecting a driver circuit having a plurality of drivers to column lines coupled to subpixels such that at least one driver is not used; and
applying a polarity to the subpixels by connected drivers to the column lines in order to provide alternating areas of dot inversion for same colored subpixels.

15. The method of claim 14, further comprising:
providing a number of adjacent areas with different polarities for same colored subpixels with a frequency of polarity changes to abate undesirable visual effects.
